(19) United States
(12) Patent Application Publication
(10) Pub. No.: US 2024/0308173 A1
(43) Pub. Date: Sep. 19, 2024

(54) FIRE-RESISTANT DRAINAGE MAT

(71) Applicant: LOUISIANA-PACIFIC CORPORATION, NASHVILLE, TN (US)

(72) Inventors: SCOTT JOHNSON, PORTLAND, OR (US); NEIL FREIDBERG, LEBANON, TN (US)

(21) Appl. No.: 18/607,217

(22) Filed: Mar. 15, 2024

Related U.S. Application Data
(60) Provisional application No. 63/452,387, filed on Mar. 15, 2023.

(51) Int. Cl. B32B 3/30; B32B 3/18; B32B 19/04; B32B 21/02; B32B 21/06; E04B 1/70; E04B 1/94

(52) U.S. Cl. CPC B32B 3/30; B32B 3/18; B32B 19/042; B32B 19/046; B32B 21/02; B32B 21/06; E04B 1/70; E04B 1/942; B32B 2260/028; B32B 2260/046; B32B 2307/304; B32B 2307/3065; B32B 2307/712; B32B 2607/00

(57) ABSTRACT

A fire-resistant (FR) drainage mat, which may be used with a multi-component fire-resistant assembly for use in various forms of construction. One or both faces of the mat have a plurality of grooves or channels, configured to serve as moisture or water flow channels. The grooves may extend in one direction, generally parallel to an edge of the panel. Alternatively, the grooves may extend in two directions, may overlap and form a grid, or take other forms. The mat is made is made of solid, rigid or semi-rigid mineral wool, fiber rock, curtain rock, thermafiber, or the like. It also may have a backing, such as a paper backing, a board, or thermafiber backing.

This application claims priority to and benefit of U.S. Provisional Application No. 63/452,387, filed Mar. 15, 2023, which is incorporated herein its entirety by specific reference for all purposes.

### FIELD OF INVENTION

This invention relates to a fire-resistant (FR) drainage mat located on the outside of an exterior panel, including but not limited to an exterior structural panel. More particularly, this invention relates to a fire-resistant drainage mat used with fire-resistant construction such as, wall assemblies with no rating and/or 30-minute to 3-hour fire resistance ratings, in accordance with ASTM E119 and NFPA 285 standard criteria, and for flame propagation and ignition resistance, in accordance with ASTM E84 standard criteria.

### BACKGROUND OF THE INVENTION

Building wall, floor and roof assemblies are typically layers of several materials, each performing a single function, that are installed separately on the site or prefabricated offsite in which the building is being constructed. Compatibility between the various layers creates challenges not only for the designer, but also for the installers.

A typical layer in most such assembles is gypsum panels or a wood panel product, or an integral composite engineered panel product, including, but not limited to, engineered wood composite products. Wood-based composites have been found to be acceptable alternatives in most cases to of wood paneling, sheathing and decking lumber. In general, wood-based composites include plywood, particle board, oriented strand board (OSB), wafer board, as well as medium density fiberboard (MDF), with the wood-based composites typically formed from a wood material combined with a thermosetting adhesive to bind the wood substrate together. Oftentimes, the adhesive is combined with other additives to impart additional properties to the wood composites. Additives can include fire retardants, insect repellants, water repellents, preservatives, and color dyes. A significant advantage of wood-based composites is that they have many of the properties of plywood, but can be made from lower grade wood species and waste from other wood product production, and can be formed into panels in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

Building wall, floor and roof assemblies typically are constructed by attaching several panels of the above-described type as to an underlying supporting structure frame as “sheathing.” These sheathing panels are often placed in a pattern forming a substantially continuous flat surface. In certain types of construction, the panels (and other construction materials) may be required under applicable building codes to meet certain fire resistance or water resistance requirements.

In prior art applications, a fire-retardant-treated (FRT) panel is installed as sheathing at a job or construction site. However, FRT lumber or plywood panels are prone to chemical leaching, and therefore need to be kept dry after installation, and otherwise withstand short-term weather exposure during construction.

Accordingly, what is needed is a wood or wood composite product panel that provides fire resistance and a protective layer to significantly reduce the leaching of fire-retardant during and after construction, without the need for a (water or weather resistant barrier) WRB system applied at the job or construction site.

### SUMMARY OF THE INVENTION

In various exemplary embodiments, the present invention comprises a fire-resistant (FR) drainage mat, which may be used with a multi-component fire-resistant assembly for use in various forms of construction. In several embodiments, the FR assembly attains 30 minutes, 1-hour, 2-hour, and/or 3-hour fire resistance ratings, in accordance with ASTM E119 and NFPA 285 standard criteria, and/or for flame propagation and ignition resistance in accordance with ASTM E84 standard criteria, and does not require any added FR panels or sheathing.

The FR drainage mat comprises a mat panel with an interior face and an exterior face. One or both faces comprise a plurality of grooves or channels, configured to serve as moisture or water flow channels. In several embodiments, the grooves extend in one direction, generally parallel to an edge of the panel (the edge may be the long edge or the short edge, depending on the intended use in construction). In some embodiments, the grooves may extend in two direction, one set parallel to one pair of opposing edges, a second set parallel to the other pair of opposing edges. The grooves may overlap, and form a grid. In alternative embodiments, one or both sets of grooves may be angled with respect to the panel edges (i.e., positioned diagonally). In further embodiments, the grooves may be curved, or S-shaped (e.g., sine wave), and may be parallel and/or non-intersecting, or may be offset and/or intersecting. Groove design, width and depth may vary to promote moisture and water drainage, according to the desired end-use. The groove or channel depth also may vary along the length of the groove. In several embodiments, the groove or channel depth may be from about one-tenth to about one-third the thickness of the drainage mat.

The FR drainage mat may be of any dimensions as needed. In several embodiments, the drainage mat has a length and width corresponding to the structural panel(s) with which it is used, as described below. The drainage mat thickness may be from about ½ inch to about 4 inches, depending on the desired fire resistance rating and/or desired structural integrity and strength. The depth of the groove/channel may vary from about 1/16^{th} to about 1½ inches, more preferably from about ⅛^{th} to about ½ inches. The width of the groove/channel may vary from 1/16^{th} to about 2 inches, more preferably from about ⅛^{th} inch to about ¼ inches.

In several embodiments, the FR drainage mat made is made of solid, rigid or semi-rigid mineral wool, fiber rock, curtain rock, thermafiber, or the like. In some embodiments, the mat also may comprise a backing, such as a paper backing, a board, or thermafiber backing.

The FR drainage mat may be installed in the field (i.e., at the construction site), or may be preinstalled at a factory or production line, typically as part of a wall assembly. The drainage mat is installed between the exterior face of a structural panel (with or without a weather-resistant barrier) and exterior cladding, and serves as a “rainscreen” to help remove moisture and water that penetrates into the space between the structural panel and the exterior cladding, while at the same time providing fire-resistance benefits to the structure.

### BRIEF DESCRIPTION OF THE DRAWINGS

FIG. 1 shows a cross-section of a fire-resistant assembly with fire-resistant (FR) drainage mat in accordance with the present invention.

FIG. 2 shows a cross-section of another fire-resistant assembly with FR drainage mat in accordance with the present invention.

FIG. 3 shows a cross-section of another fire-resistant assembly with FR drainage mat in accordance with the present invention.

FIGS. 4A-H show face views of a FR drainage mat with various configurations of grooves or channels.

### DESCRIPTION OF INVENTION

In various exemplary embodiments, the present invention comprises a fire-resistant (FR) drainage mat 50, which may be used with a multi-component fire-resistant assembly for use in various forms of construction. In several embodiments, the FR assembly attains 30 minutes, 1-hour, 2-hour, and/or 3-hour fire resistance ratings, in accordance with ASTM E119 and NFPA 285 standard criteria, and/or for flame propagation and ignition resistance in accordance with ASTM E84 standard criteria, and does not require any added FR panels or sheathing.

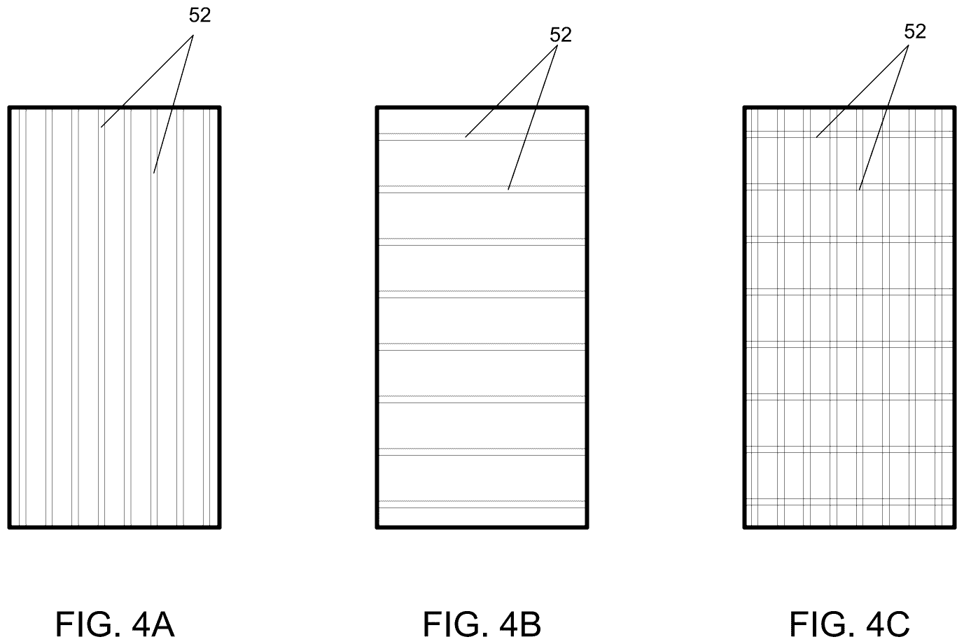

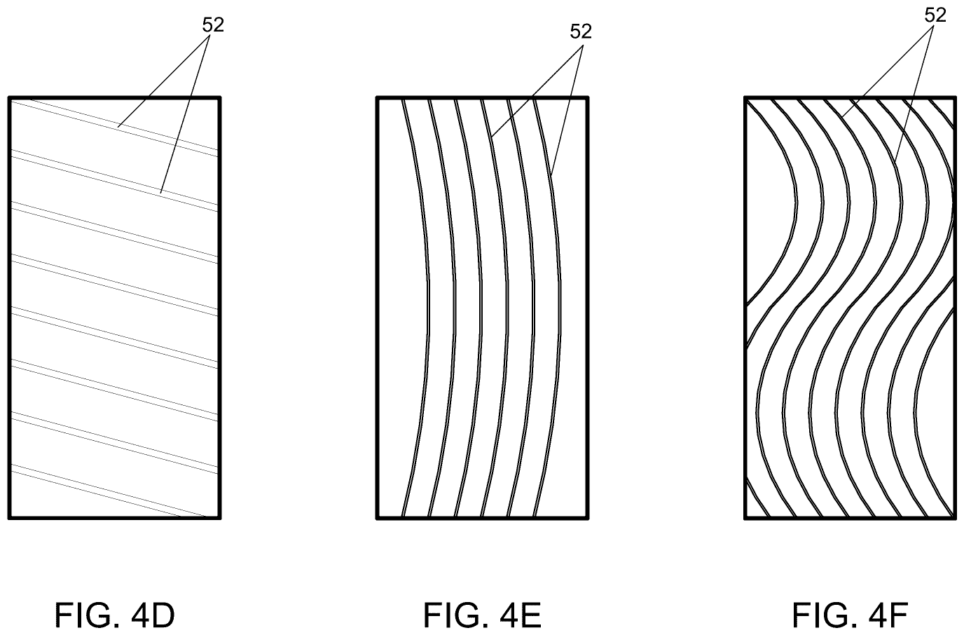

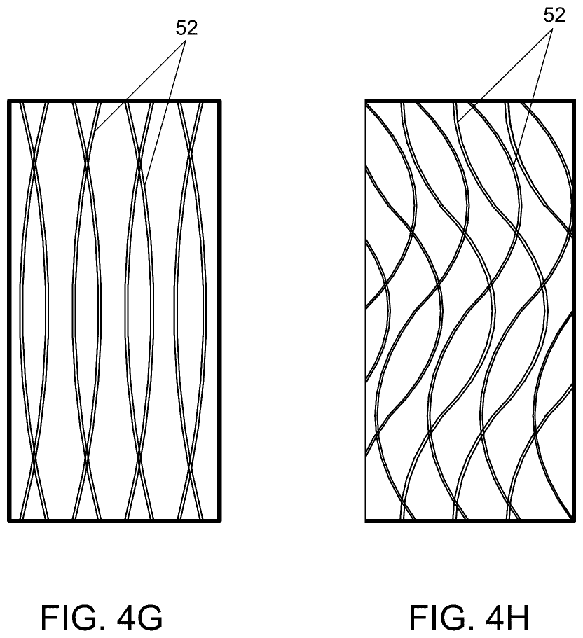

The FR drainage mat 50 comprises a mat panel with an interior face and an exterior face. As seen in FIGS. 4A-H, one or both faces comprise a plurality of grooves or channels 52, configured to serve as moisture or water flow channels. In several embodiments, the grooves extend in one direction, generally parallel to an edge of the panel (the edge may be the long edge or the short edge, depending on the intended use in construction). In some embodiments, the grooves may extend in two directions, one set parallel to one pair of opposing edges, a second set parallel to the other pair of opposing edges. The grooves may overlap, and form a grid. In alternative embodiments, one or both sets of grooves may be angled with respect to the panel edges (i.e., positioned diagonally). In further embodiments, the grooves may be curved, or S-shaped (e.g., sine wave), and may be parallel and/or non-intersecting, or may be offset and/or intersecting. Groove design, width and depth may vary to promote moisture and water drainage, according to the desired end-use. The groove or channel depth also may vary along the length of the groove. In several embodiments, the groove or channel depth may be from about one-tenth to about one-third the thickness of the drainage mat.

The FR drainage mat may be of any dimensions as needed. In several embodiments, the drainage mat has a length and width corresponding to the structural panel(s) with which it is used, as described below. The drainage mat thickness may be from about ½ inch to about 4 inches, depending on the desired fire resistance rating and/or desired structural integrity and strength. The depth of the groove/channel may vary from about 1/16^{th} to about 1½ inches, more preferably from about ⅛^{th} to about ½ inches. The width of the groove/channel may vary from 1/16^{th} to about 2 inches, more preferably from about ⅛^{th} inch to about ¼ inches.

In several embodiments, the FR drainage mat made is made of solid, rigid or semi-rigid mineral wool, fiber rock, curtain rock, thermafiber, or the like. In some embodiments, the mat also may comprise a backing, such as a paper backing, a board, or thermafiber backing.

The FR drainage mat 50 may be installed in the field (i.e., at the construction site), or may be preinstalled at a factory or production line, typically as part of a wall assembly. The drainage mat is installed between the exterior face of a structural panel (with or without a weather-resistant barrier) and exterior cladding, and serves as a “rainscreen” to help remove moisture and water that penetrates into the space between the structural panel and the exterior cladding, while at the same time providing fire-resistance benefits to the structure.

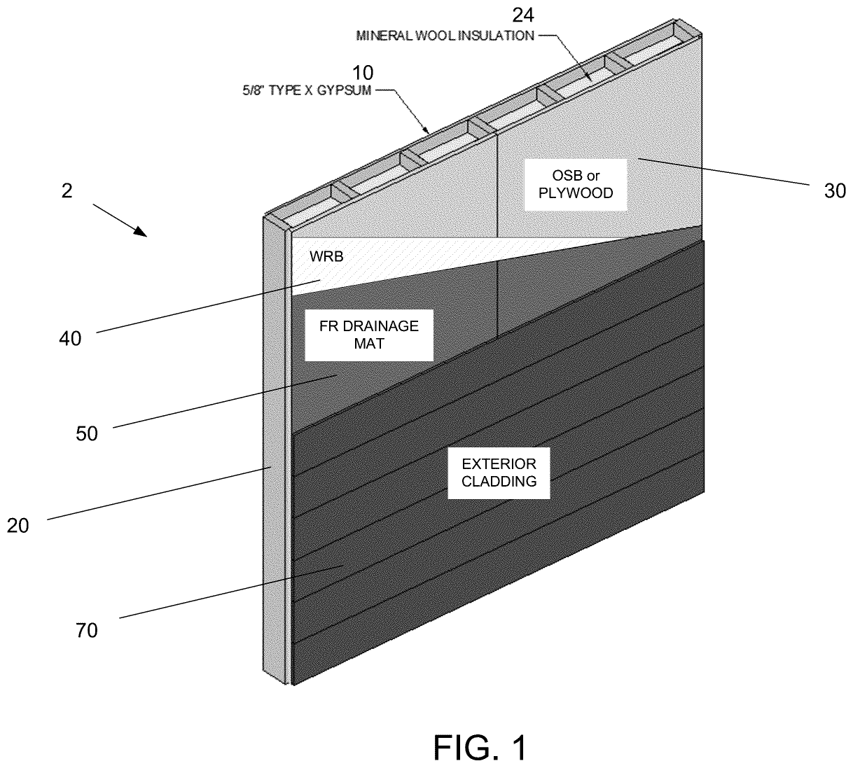

FIG. 1 shows an example of an FR wall assembly 2 with an FR drainage mat 50. The FR wall assembly comprises an interior layer 10, a plurality of supporting studs 20, an exterior layer 30, a weather-resistant barrier (WRB) layer 40, a FR drainage mat 50, and, in some embodiments, an outermost layer 70. The placement of the studs 20 creates a cavity between the interior layer and the exterior layer. This cavity typically may be filled, wholly or partially, with an insulating material 24.

The interior layer 10 may comprise gypsum, stucco, plaster, wood, wood composite, or similar material. The interior layer also may comprise a structural panel (e.g., an OSB panel or CDX panel) in conjunction with these materials.

The studs 20 may comprise wood or metal studs. The cavity-filling material 24 may comprise batt insulation (e.g., fiberglass, mineral wool or mineral wool products), foam, close-cell or open-cell foam, cellulose, blown-in insulation. Mineral wool (also referred to as mineral fiber, mineral cotton, mineral fiber, alkaline earth silicate wool, alumino silicate wool, polycrystalline woo, kaowool, man-made mineral fiber, and man-made vitreous fiber) is any fibrous material formed by spinning or drawing molten material or rock or stone material, including, but not limited to, slag and ceramics. Mineral wool products for purposes of this application include, but are not limited to, mineral wool rolls, mineral wool sheets, mineral board, mineral wool board, mineral fiber board, mineral bonded wood wool board, ceramic fiber board, resin-bonded panels, stone wool, glass wool, and slag wool. In some embodiments, the cavity 22 may be left unfilled (i.e., no insulation).

The exterior layer 30 may comprise a wood or structural wood-composite panel, such as an OSB or CDX panel, or a layer of gypsum. It also may comprise a metal or other form of panel. The outermost layer 70 may comprise a form of cladding, siding (e.g., lap, panel, shake, or the like), stucco, brick, masonry, stone, metal, vinyl, wood, engineered wood, fiber cement, or the like. The exterior layer 30 and/or outermost layer 70 also may comprise insulation, such as, but not limited to, foam-board, mineral wool, mineral board, or various mineral wool products (as described above).

In an exemplary, non-limiting examples, the interior layer is a ⅝″ thick interior type X gypsum panel. The studs are 2×6″ wood studs, vertically spaced at 16 inches, and the cavity is filled with mineral wool or mineral wool products insulation (as described above). The exterior layer is 7/16″ thick OSB or plywood structural panel, with an integrated WRB (weather-resistant barrier), such as a resin-impregnated paper overlay attached during a manufacturing process (alternative forms include a liquid or fluid-applied WRB, a closed-cell foam, or a polymer film). The FR drainage mat is 1-inch mineral wool, grooved on the outer face. The outermost layer is wood-based exterior panel siding (i.e., exterior cladding). Between the outermost layer and WRB may be some form of exterior insulation.

The FR assembly from the exterior side is unique in that it only requires the exterior siding/cladding 70, the FR drainage mat 50, and a WRB and exterior layer 30, 40 (e.g., panel). It does not require any additional exterior gypsum panels or layer, FR panels, non-combustible materials, or FR coatings. It is also unique that the FR assembly may alternatively only require exterior insulation 70 over the WRB and exterior layer 30, 40 (e.g., panel).

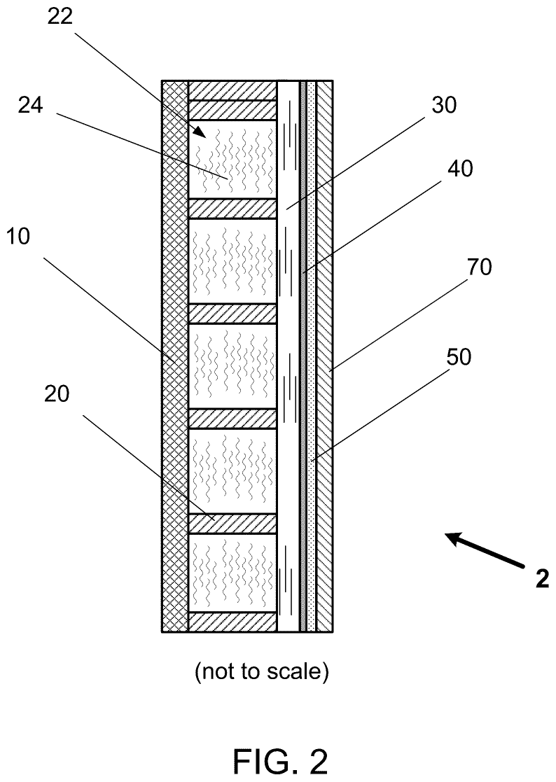

FIG. 2 shows an alternative embodiment of a FR assembly 2 comprising a 1-hour fire rated wall assembly. The interior layer 10 is ⅝″ interior type X gypsum. The studs 20 are 2×6″ wood studs, vertically spaced at 16 or 24 inches, and the cavity 22 is filled with fiberglass, cellulose, foam, particulates, mineral wool or mineral wool products insulation 24 (as described above). The exterior panel 30 is an OSB or plywood panel (although it may also be gypsum, as described above), with a WRB 40 on the outer face. The FR drainage mat 50 is ½″ mineral wool, grooved on the inner face. The outermost layer 70 is minimum ⅜″ wood-based exterior panel siding (i.e., exterior cladding).

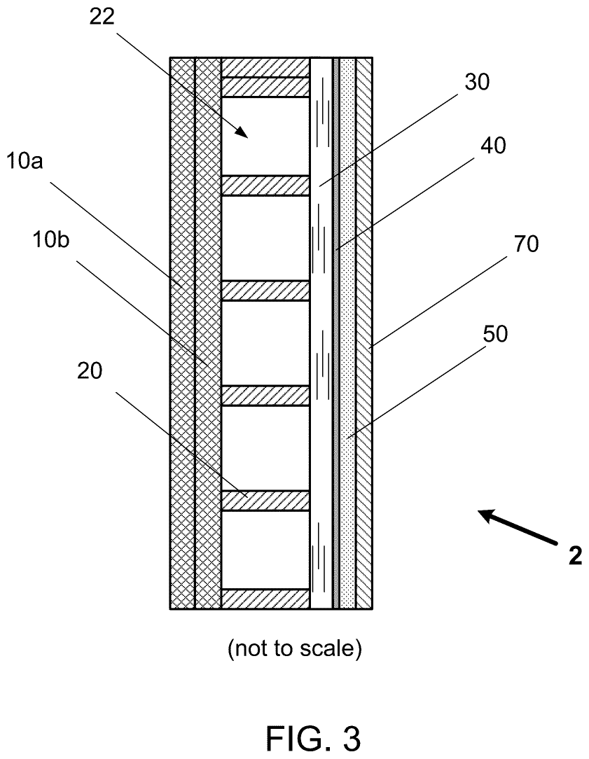

FIG. 3 shows an alternative embodiment of a FR assembly 2 comprising a 2-hour fire rated wall assembly. The interior layer comprises two layers 10a,b of ⅝″ interior type X gypsum. The studs 20 are 2×6″ wood studs, vertically spaced at 16 or 24 inches, and the cavity 22 may be empty, as shown, or alternatively may be filled with fiberglass, cellulose, foam, particulates, mineral wool or mineral wool products insulation 24 (as described above). The exterior panel 30 is an OSB or plywood panel (although it may also be gypsum, as described above), with a WRB 40 on the outer face. The FR drainage mat 50 is 2″ mineral wool, grooved on the outer face. The outermost layer 70 is minimum ⅜″ wood-based exterior panel siding (i.e., exterior cladding).

The FR assembly 2 with drainage mat 50 thus provides a building-code-approved product that provides structural performance and fire resistance characteristics for use in wall, floor and roof applications that require a fire resistance performance, such as residential, single- or multi-family, light framed mid-rise and commercial construction.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A fire-resistant drainage mat, comprising:
a mat panel with a first face and a second face, each face with a first edge and a second edge;
a plurality of grooves or channels in the first face, configured to contain and/or direct moisture or water flow therein;
wherein the mat panel comprises fire-resistant material.

2. The fire-resistant drainage mat of claim 1, wherein the mat panel comprises mineral wool, fiber rock, curtain rock, thermafiber, or combinations thereof.

3. The fire-resistant drainage mat of claim 1, wherein the mat panel is rigid.

4. The fire-resistant drainage mat of claim 1, further comprising a backing layer.

5. The fire-resistant drainage mat of claim 4, wherein the backing layer comprises a paper backing, a board, or thermafiber.

6. The fire-resistant drainage mat of claim 1, wherein at least some of the plurality of grooves or channels extend between the first edge and the second edge of the first face.

7. The fire-resistant drainage mat of claim 1, wherein at least some of the plurality of grooves or channels are parallel to the first edge or the second edge.

8. The fire-resistant drainage mat of claim 1, wherein at least some of the plurality of grooves or channels are curved.

9. The fire-resistant drainage mat of claim 1, wherein at least some of the plurality of grooves or channels overlap and/or intersect.

10. The fire-resistant drainage mat of claim 1, further comprising a second plurality of grooves or channels in the second face.

11. A fire-resistant wall assembly, comprising:
an assembly comprising a first panel, a second panel, and one or more connection elements therebetween; and
a fire-resistant drainage mat as set forth in claim 1, overlaying a side of the second panel opposite the one or more connection elements.

12. The fire-resistant wall assembly of claim 11, wherein one or more connection elements are studs.

13. The fire-resistant wall assembly of claim 11, further comprising a weather-resistant barrier layer disposed between the second panel and the fire-resistant drainage mat.

14. The fire-resistant wall assembly of claim 11, further comprising an outermost layer overlaying a face of the fire-resistant drainage mat opposite the second panel.

15. The fire-resistant wall assembly of claim 11, further comprise at least one cavity disposed between the first panel and second panel, said at least one cavity filled in whole or in part with insulating material.
